(19) United States
(12) Patent Application Publication
(10) Pub. No.: US 2026/0362476 A1
(43) Pub. Date: Nov. 12, 2026

(54) Methods And Apparatus For Random Access Preamble Format And Generation In Wireless Communications

(71) Applicant: MediaTek Singapore Pte. Ltd., Singapore (SG)

(72) Inventors: Chenmeng Li, Beijing (CN); Jiann-Ching Guey, Hsinchu City (TW); Chiou-Wei Tsai, Hsinchu City (TW); Wen Tang, Beijing (CN); Wei-De Wu, Hsinchu City (TW); Lung-Sheng Tsai, Hsinchu City (TW)

(73) Assignee: MediaTek Singapore Pte. Ltd., Singapore (SG)

(21) Appl. No.: 19/671,218

(22) Filed: May 7, 2026

(30) Foreign Application Priority Data
May 9, 2025 (WO) PCT/CN2025/093908
May 1, 2026 (CN) 202610605320.2

(51) Int. Cl. H04W 74/00; H04L 27/26

(52) U.S. Cl. CPC H04W 74/004; H04L 27/2607

(57) ABSTRACT

Various solutions for random access preamble format and generation in wireless communications are described. A user equipment (UE) may generate a random access preamble sequence based on a base sequence by performing one or more cyclic shift operations. The UE may transmit one or multiple repetitions of the random access preamble sequence in a physical random access channel (PRACH) occasion. The base sequence may be generated in a time domain or a frequency domain, the one or more cyclic shift operations may be performed in at least one of the time domain and the frequency domain, and in an event that the base sequence is generated in the time domain, the one or more cyclic shift operations comprise a cyclic shift operation performed in the frequency domain.

### CROSS REFERENCE TO RELATED PATENT APPLICATION(S)

The present disclosure is part of a non-provisional application claiming the priority benefit of PCT Application No. PCT/CN2025/093908, filed 9 May 2025, and CN application No. 202610605320.2, filed 1 May 2026, the content of which herein being incorporated by reference in their entirety.

### TECHNICAL FIELD

The present disclosure is generally related to wireless communications and, more particularly, to methods and apparatus for random access preamble format and generation in wireless communications.

### BACKGROUND

Unless otherwise indicated herein, approaches described in this section are not prior art to the claims listed below and are not admitted as prior art by inclusion in this section.

Wireless communication systems continue to evolve to support higher data rates, lower latency, and a broader range of application scenarios. Modern communication networks are required to provide stable and efficient access capabilities for a large number of terminal devices under varying propagation environments, coverage conditions, and resource configurations. As system scale expands and deployment forms diversify, the scalability and flexibility of signal design and access mechanisms have become increasingly important factors affecting overall system performance.

In communication systems, access signals are typically used to establish an initial communication connection between a terminal device and a network. Such signals are generally generated based on specific sequence structures and transmitted over predefined channels. The structural design of access signals directly impacts synchronization performance, detection reliability, and resource utilization efficiency. Under high-load conditions or complex propagation environments, the distinguishability among access signals and the management of signal collisions become particularly critical. As communication scenarios expand to include larger coverage areas, higher mobility conditions, or more diverse deployment environments, access signal generation mechanisms may require enhanced adaptability. Variations in propagation characteristics, frequency conditions, and delay profiles across different environments may influence the design considerations of access signals and the overall performance of the system.

Furthermore, the manner in which access signals are generated and the structure of parameter configurations may affect the number of distinguishable signals that can be supported, the correlation properties among sequences, and implementation complexity. As system scale increases or access density grows, conventional signal generation mechanisms may encounter limitations in scalability or flexibility. Accordingly, there is a need for more flexible and scalable access signal generation mechanisms that can better adapt to varying operating conditions and deployment requirements, thereby improving overall system access performance and resource utilization efficiency.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods, and apparatus pertaining to random access preamble format and generation in wireless communications. It is believed that the above-described issue would be avoided or otherwise alleviated by implementing one or more of the proposed schemes described herein.

In one aspect, a method may involve a user equipment (UE) generating a random access preamble sequence based on a base sequence by performing one or more cyclic shift operations. The method may also involve the UE transmitting one or multiple repetitions of the random access preamble sequence in a physical random access channel (PRACH) occasion. The base sequence may be generated in a time domain or a frequency domain, the one or more cyclic shift operations may be performed in at least one of the time domain and the frequency domain, and in an event that the base sequence is generated in the time domain, the one or more cyclic shift operations may comprise a cyclic shift operation performed in the frequency domain.

In one aspect, a method may involve a user equipment (UE) generating one of a plurality of random access preamble sequences for a physical random access channel (PRACH) occasion. The generating of the plurality of random access preamble sequences may comprise enumerating a combination of a logical root sequence index, a time-domain cyclic shift value, and a frequency-domain cyclic shift value, in a predefined generation order.

In one aspect, a method may involve a network node configuring a user equipment (UE) with parameters for generating a random access preamble sequence. The method may also involve the network node receiving one or multiple repetitions of the random access preamble sequence from the UE in a physical random access channel (PRACH) occasion. The parameters may indicate that a base sequence is to be generated in a time domain or a frequency domain, the parameters may further indicate that one or more cyclic shift operations are to be performed in at least one of the time domain and the frequency domain, and in an event that the base sequence is generated in the time domain, the parameters may indicate that the one or more cyclic shift operations comprise a cyclic shift operation performed in the frequency domain.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario in accordance with an implementation of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of another example process in accordance with an implementation of the present disclosure.

FIG. 6 is a flowchart of another example process in accordance with an implementation of the present disclosure.

FIG. 7 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes, and/or solutions pertaining to methods and apparatus for random access preamble format and generation in wireless communications. According to the present disclosure, a number of possible solutions may be implemented separately or jointly. That is, although these possible solutions may be described below separately, two or more of these possible solutions may be implemented in one combination or another.

In some implementations of the present disclosure, wireless communication systems may be deployed in various scenarios, including but not limited to terrestrial network (TN) scenarios and non-terrestrial network (NTN) scenarios. An NTN may refer to a network that utilizes radio frequency (RF) and information processing resources carried on satellites or other high-altitude communication platforms to provide communication services for user equipments (UEs). Compared with conventional TN deployments, such scenarios may involve extended coverage areas, different propagation characteristics, and design constraints on signal transmission periodicity. Accordingly, mechanisms for system information acquisition and initial access are expected to operate efficiently across both TN and NTN deployments.

In wireless communication systems, the generation of preamble sequences plays an important role in system performance. Preamble sequences are widely used for synchronization, channel estimation, initial access, and other essential signaling functions. The structure and generation mechanism of preamble sequences affect detection reliability, collision probability, scalability, and overall access efficiency. In current new radio (NR) systems, random access preambles are typically generated based on Zadoff-Chu (ZC) sequences. ZC sequences exhibit desirable correlation properties and support cyclic shift operations for generating multiple distinguishable preambles from a common root sequence. In general, cyclic shifts may theoretically be applied in either the time domain (TD) or the frequency domain (FD). However, in current NR baseline designs, cyclic shift operations are performed in a single domain.

In some options of NR baseline generation procedures, a root sequence is selected in the time domain. A cyclic shift is then applied in the time domain to generate different preamble sequences. The resulting sequence is transformed to the frequency domain via a discrete Fourier transform (DFT), mapped to resource elements (REs), converted back to the time domain via an inverse fast Fourier transform (IFFT), and subsequently transmitted. In such baseline configurations, frequency-domain cyclic shifts are not utilized as part of the preamble differentiation mechanism. As wireless systems evolve toward future generations, such as sixth generation (6G) systems, more flexible and scalable random access channel (RACH) configurations may be desirable. In some implementations, sequences without real-frequency ambiguity may be adopted, allowing support for both time-domain and frequency-domain cyclic shifts. Under such configurations, the preamble generation procedure may differ from the conventional NR baseline design, and new configurable parameters may be introduced.

In some implementations, a time-domain cyclic shift value (CTV) may indicate the amount of cyclic shift applied in the time domain. In some implementations, a frequency-domain cyclic shift value (CFV) may be introduced to indicate the amount of cyclic shift applied in the frequency domain. While CTV is present in current NR systems, CFV may be newly introduced in future systems to enable additional flexibility in preamble generation. In some implementations, preamble sequence generation may be based on a time-domain base sequence. Cyclic shift operations may be applied in the time domain, in the frequency domain, or in both domains. When both domains are utilized, enhanced sequence diversity and scalability may be achieved, which may improve performance under various deployment scenarios, including terrestrial networks (TN) and non-terrestrial networks (NTN). In some implementations, preamble sequence generation may alternatively be based on a frequency-domain base sequence. In such implementations, cyclic shifts may likewise be applied in the time domain, in the frequency domain, or in both domains. This dual-domain capability may provide increased flexibility in adapting to different bandwidth configurations, propagation conditions, and system requirements.

In some implementations, a predefined preamble generation order may be specified to determine how combinations of logical root sequence indices and cyclic shift values are enumerated. The generation order may influence grouping behavior, detection characteristics, or resource allocation flexibility. In some implementations, when cyclic shifts are applied only in the time domain, the generation order may be defined in increasing order of a time-domain cyclic shift value of a logical root, followed by a logical root sequence index. In some other implementations, the generation order may be determined in increasing order of a logical root sequence index, followed by a time-domain cyclic shift value. In some implementations, when cyclic shifts are applied only in the frequency domain, the generation order may be defined in increasing order of a frequency-domain cyclic shift value of a logical root, followed by a logical root sequence index. In some other implementations, the generation order may be defined in increasing order of a logical root sequence index, followed by a frequency-domain cyclic shift value.

In some implementations, when cyclic shifts are applied in both the time domain and the frequency domain, multiple enumeration structures may be supported. For example, the generation order may be determined in increasing order of a time-domain cyclic shift value, then a frequency-domain cyclic shift value, and then a logical root sequence index; a frequency-domain cyclic shift value, then a time-domain cyclic shift value, and then a logical root sequence index; a time-domain cyclic shift value, then a logical root sequence index, and then a frequency-domain cyclic shift value; a frequency-domain cyclic shift value, then a logical root sequence index, and then a time-domain cyclic shift value; a logical root sequence index, then a time-domain cyclic shift value, and then a frequency-domain cyclic shift value; and a logical root sequence index, then a frequency-domain cyclic shift value, and then a time-domain cyclic shift value. Through flexible base sequence selection, dual-domain cyclic shift configuration, and configurable generation ordering, scalable enhancements for 6G initial access and random access preamble generation may be achieved. More specifically, the present disclosure proposes to consider the following exemplary proposals.

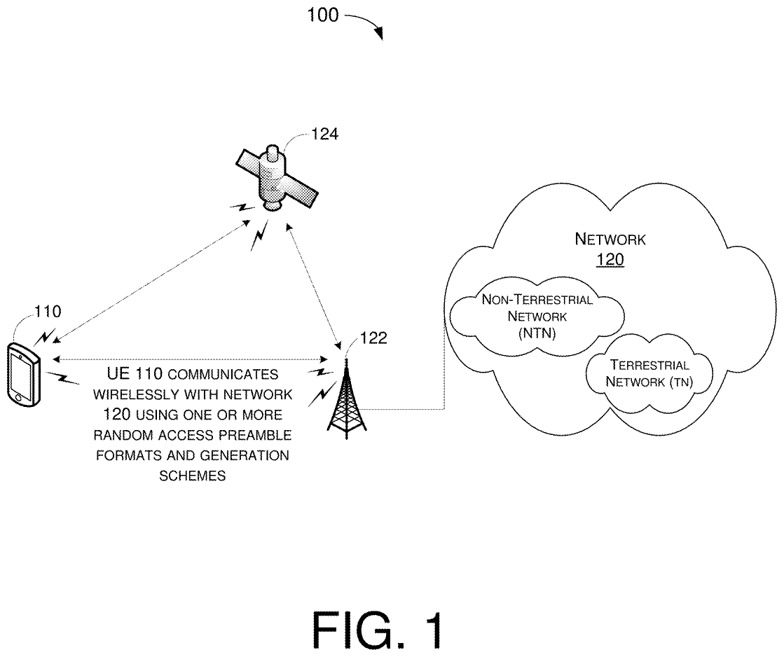

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 122 (e.g., a base station (BS) such as an eNB, a Next Generation Node-B (gNB), a transmission/reception point (TRP), a relay, or a gateway) and/or a non-terrestrial network node 124 (e.g., a satellite). For example, in transparent payload mode, the terrestrial network node 122 (e.g., a BS) and the non-terrestrial network node 124 (e.g., a satellite operating as a relay) may form an NTN serving cell for wireless communication with the UE 110. In regenerative payload mode, the non-terrestrial network node 124 (e.g., a satellite) may have a full/part of gNB function and may be able to form an NTN serving cell for wireless communication with the UE 110, with or without involving the terrestrial network node 122 (e.g., a BS). Alternatively, the terrestrial network node 122 may form a TN serving cell for wireless communication with the UE 110. In such a communication environment, the UE 110, the network 120, and the terrestrial network node 122 and/or the non-terrestrial network node 124 may implement various schemes pertaining to random access preamble format and generation in wireless communications in accordance with the present disclosure, as described below. It is noteworthy that, while the various proposed schemes may be individually or separately described below, in actual implementations, some or all of the proposed schemes may be utilized or otherwise implemented jointly. Of course, each of the proposed schemes may be utilized or otherwise implemented individually or separately.

It should be noted that the base sequence used for preamble generation may be selected from various sequence families possessing desirable correlation properties. In some implementations, the base sequence may be at least one of the following: an M (maximum length) sequence, a Gold sequence, a Z4 sequence, a 4-phase sequence, a Zadoff-Chu (ZC) sequence, a Constant Amplitude Zero Auto-Correlation (CAZAC) sequence, a poly-phase sequence, a sequence generated via a Golomb ruler, and a pseudo-random sequence. In some implementations, other sequence structures exhibiting suitable auto-correlation and cross-correlation characteristics may also be used.

In one aspect of the present disclosure, a method for generating a preamble sequence based on a time-domain (TD) base sequence is provided. In some implementations, the TD base sequence may be directly used as a starting sequence for preamble generation. In some implementations, one or more cyclic shift operations may be applied to the TD base sequence to generate multiple distinguishable preamble sequences derived from a common logical root sequence. In some implementations, the cyclic shift operation applied to the TD base sequence may be performed in the time domain. In some other implementations, the cyclic shift operation may be performed in the frequency domain. In further implementations, cyclic shift operations may be performed in both the time domain and the frequency domain. By enabling such domain-flexible cyclic shift configurations, the generated preamble sequences may exhibit enhanced diversity and scalability under various deployment conditions. In some implementations, alternative sequence manipulation strategies may also be considered, depending on system requirements, bandwidth configurations, or propagation environments. Accordingly, the disclosed preamble sequence generation framework may be adapted to different communication scenarios while maintaining desirable correlation and detection performance.

In some implementations, the disclosed preamble generation framework may be categorized into the following sequence-root types: Time-domain sequence as root and frequency-domain sequence as root. Proposal #1 focuses on the case where the time-domain sequence serves as the logical root. In one aspect of the present disclosure, Proposal #1 provides a preamble sequence generation method based on a time-domain (TD) base sequence. In some implementations, the TD base sequence may serve as a logical root sequence for generating random-access preambles. Multiple distinguishable preambles may be derived from the same logical root sequence by applying cyclic shift operations in one or more domains. In some implementations, the method may include the following alternative configurations.

### Option 1: With Sequence Cyclic Shift in TD.

In some implementations, the set of random-access preambles x_{u,tv}(n) may be generated according to: x_{u,tv}(n)=xᵤ((n+Cₜᵥ)mod L_{RA}), n=0, 1, 2, . . . , L_{RA}−1. xᵤ(i)=seq(i), i=0, 1, 2, . . . , L_{RA}−1. In some implementations, the sequence seq of length L_{RA} may be a sequence of good cross-correlation and/or auto-correlation property, the Cₜᵥ may be the cyclic shift value in the time domain. The cyclic shift value Cₜᵥ may be determined as:

$${C}_{tv} = \{ \begin{matrix}{vN}_{tcs} , & v = 0 , 1 , … , ⌊ \frac{{L}_{RA}}{{N}_{tcs}} ⌋ - 1 , {N}_{tcs} \neq 0 \\ 0 , & {N}_{tcs} = 0\end{matrix} .$$

In some implementations, the value of N_{tcs} may be determined by a predefined table or calculated via one or more formulas. The frequency domain representation may be generated according to:

$${y}_{u , tv} ( n ) = {\sum }_{m = 0}^{{L}_{RA} - 1} {x}_{u , tv} ( m ) \cdot {e}^{\frac{j 2 π mn}{{L}_{RA}}} .$$

L_{RA} may be the sequence length, depending on the pre-defined or pre-configured PRACH preamble format. In some implementations, this configuration corresponds to the baseline NR preamble generation mechanism.

### Option 2: With Sequence Cyclic Shift in FD.

In some implementations, cyclic shift may be applied in the frequency domain. The set of random-access preambles x_{u,fv}(n) may be generated according to:

$${x}_{u , fv} ( n ) = {x}_{u} ( n ) {e}^{\frac{j 2 π {C}_{fv} n}{N}} , n = 0 , 1 , 2 , … , {L}_{RA} - 1.$$

xᵤ(i)=seq(i), i=0, 1, 2, . . . , L_{RA}−1. The sequence seq of length L_{RA} may be a sequence of good cross-correlation and/or auto-correlation property, the C_{fv} may be the cyclic shift value in the frequency domain. The cyclic shift value C_{fv} may be determined as:

$${C}_{fv} = \{ \begin{matrix}{vN}_{fcs} , & v = 0 , 1 , … , ⌊ \frac{{L}_{RA}}{{N}_{fcs}} ⌋ - 1 , {N}_{fcs} \neq 0 \\ 0 , & {N}_{fcs} = 0\end{matrix} .$$

In some implementations, the value of N_{fcs} may be determined by a predefined table or calculated via one or more formulas. The frequency domain representation may be generated according to:

$${y}_{u , fv} ( n ) = {\sum }_{m = 0}^{{L}_{RA} - 1} {x}_{u , fv} ( m ) \cdot {e}^{\frac{j 2 π mn}{{L}_{RA}}} .$$

L_{RA} may be the sequence length, depending on the pre-defined or pre-configured PRACH preamble format. In some implementations, this configuration introduces a frequency-domain cyclic shift value (CFV), thereby extending the preamble generation capability beyond the existing NR baseline structure.

### Option 3: With Sequence Cyclic Shift in TD and FD.

In some implementations, cyclic shift operations may be applied in both the time domain and the frequency domain. The set of random-access preambles x_{u,tv,fv}(n) may be generated according to:

$${x}_{u , tv , fv} ( n ) = {x}_{u} ( ( n + {C}_{tv} ) mod {L}_{RA} ) {e}^{\frac{j 2 π {C}_{fv} n}{N}} , n = 0 , 1 , 2 , … , {L}_{RA} - 1.$$

xᵤ(i)=seq(i), i=0, 1, 2, . . . , L_{RA}−1. The sequence seq of length L_{RA} may be a sequence of good cross-correlation and/or auto-correlation property, the Cₜᵥ may be the cyclic shift value in the time domain, the C_{fv} may be the cyclic shift value in the frequency domain. The cyclic shift value Cₜᵥ may be determined as:

$${C}_{tv} = \{ \begin{matrix}{vN}_{tcs} , & v = 0 , 1 , … , ⌊ \frac{{L}_{RA}}{{N}_{tcs}} ⌋ - 1 , {N}_{tcs} \neq 0 \\ 0 , & {N}_{tcs} = 0\end{matrix} .$$

The cyclic shift value C_{fv} may be determined as:

$${C}_{fv} = \{ \begin{matrix}{vN}_{fcs} , & v = 0 , 1 , … , ⌊ \frac{{L}_{RA}}{{N}_{fcs}} ⌋ - 1 , {N}_{fcs} \neq 0 \\ 0 , & {N}_{fcs} = 0\end{matrix} .$$

In some implementations, the parameters Ctv and Cfv may be determined according to the previously described definitions. The value of N_{tcs} and N_{fcs} may be determined by a predefined table or calculated via one or more formulas. The frequency domain representation may be generated according to:

$${y}_{u , tv , fv} ( n ) = {\sum }_{m = 0}^{{L}_{RA} - 1} {x}_{u , tv , fv} ( m ) \cdot {e}^{\frac{j 2 π mn}{{L}_{RA}}} .$$

L_{RA} may be the sequence length, depending on the pre-defined or pre-configured PRACH preamble format. In some implementations, this dual-domain configuration allows simultaneous use of time-domain cyclic shift (CTV) and frequency-domain cyclic shift (CFV), thereby enhancing sequence diversity and scalability for future communication systems.

In another aspect of the present disclosure, Proposal #2 provides a preamble sequence generation method based on a frequency-domain (FD) sequence. In some implementations, the base sequence for generating random-access preambles may be defined directly in the frequency domain. In such configurations, the logical root sequence may inherently exist in the frequency domain representation, thereby reducing certain transformation steps compared to time-domain-rooted structures. More specifically, Proposal #2 provides alternative configurations as described below.

### Option 1: With Sequence Cyclic Shift in TD.

In some implementations, the frequency domain representation of the set of random-access preambles x_{u,tv}(n) may be generated according to:

$${x}_{u , tv} ( n ) = {x}_{u} ( n ) {e}^{\frac{j 2 π {C}_{tv} n}{N}} , n = 0 , 1 , 2 , … , {L}_{RA} - 1.$$

xᵤ(i)=seq(i), i=0, 1, 2, . . . , L_{RA}−1. In some implementations, the sequence seq of length L_{RA} may be a sequence of good cross-correlation and/or auto-correlation property, and the Cₜᵥ may be the cyclic shift value in time domain. The cyclic shift value Cₜᵥ may be determined as:

$${C}_{tv} = \{ \begin{matrix}{vN}_{tcs} , & v = 0 , 1 , … , ⌊ \frac{{L}_{RA}}{{N}_{tcs}} ⌋ - 1 , {N}_{tcs} \neq 0 \\ 0 , & {N}_{tcs} = 0\end{matrix} .$$

In some implementations, the value of N_{tcs} may be provided by a predefined table or calculated via one or more formulas. The frequency domain representation may be generated according to: y_{u,tv}(n)=x_{u,tv}(n). L_{RA} may be the sequence length, depending on the pre-defined or pre-configured PRACH preamble format. In some implementations, the generation flow may include FD root sequence, IFFT transformation to time domain, time-domain cyclic shift, and transmission.

### Option 2: With Sequence Cyclic Shift in FD.

In some implementations, cyclic shift may be performed directly in the frequency domain. The frequency domain representation of the set of random-access preambles x_{u,fv}(n) may be generated according to: x_{u,fv}(n)=xᵤ(n+C_{fv})mod L_{RA}), n=0, 1, 2, . . . , L_{RA}−1. x₄(i)=seq(i), i=0, 1, 2, . . . , L_{RA}−1. The sequence seq of length L_{RA} may be a sequence of good cross-correlation and/or auto-correlation property, and the Cᵣᵥ may be the cyclic shift value in frequency domain. The cyclic shift value C_{fv} may be determined as: C_{fv}=

$$\{ \begin{matrix}{vN}_{fcs} , & v = 0 , 1 , … , ⌊ \frac{{L}_{RA}}{{N}_{fcs}} ⌋ - 1 , {N}_{fcs} \neq 0 \\ 0 , & {N}_{fcs} = 0\end{matrix} .$$

In some implementations, the value of N_{fcs} may be provided by a predefined table or calculated via one or more formulas. The frequency domain representation may be generated according to: y_{u,fv}(n)=x_{u,fv}(n). L_{RA} may be the sequence length, depending on the pre-defined or pre-configured PRACH preamble format. In some implementations, the generation flow may include FD root sequence, frequency-domain cyclic shift, IFFT, and transmission.

### Option 3: With Sequence Cyclic Shift in TD and FD.

In some implementations, cyclic shift operations may be applied in both the frequency domain and the time domain. The frequency domain representation of the set of random-access preambles x_{u,tv,fv}(n) may be generated according to:

$${x}_{u , tv , fv} ( n ) = {x}_{u} ( ( n + {C}_{fv} ) mod {L}_{RA} ) {e}^{\frac{j 2 π {C}_{tv} n}{N}} , n = 0 , 1 , 2 , … , {L}_{RA} - 1.$$

$${x}_{u} ( i ) = seq ( i ) , i = 0 , 1 , 2 , … , {L}_{RA} - 1.$$

The sequence seq of length L_{RA} may be a sequence of good cross-correlation and/or auto-correlation property, the Cₜᵥ may be the cyclic shift value in time domain, the C_{fv} may be the cyclic shift value in frequency domain. In some implementations, the cyclic shift value Cₜᵥ may be determined as:

$${C}_{tv} = \{ \begin{matrix}{vN}_{tcs} , & v = 0 , 1 , … , ⌊ \frac{{L}_{RA}}{{N}_{tcs}} ⌋ - 1 , {N}_{tcs} \neq 0 \\ 0 , & {N}_{tcs} = 0\end{matrix} .$$

In some implementations, the cyclic shift value C_{fv} may be determined as:

$${C}_{fv} = \{ \begin{matrix}{vN}_{fcs} , & v = 0 , 1 , … , ⌊ \frac{{L}_{RA}}{{N}_{fcs}} ⌋ - 1 , {N}_{fcs} \neq 0 \\ 0 , & {N}_{fcs} = 0\end{matrix} .$$

In some implementations, the value of N_{tcs} and N_{fcs} are provided by a predefined table or calculated via one or more formulas. The frequency domain representation may be generated according to: y_{u,tv,fu}(n)=x_{u,tv,fv}(n). L_{RA} may be the sequence length, depending on the pre-defined or pre-configured PRACH preamble format.

In some implementations, the generation flow may include the FD root sequence, frequency-domain cyclic shift, IFFT, time-domain cyclic shift, and transmission. In some implementations, the underlying sequence structure used for TD-root and FD-root approaches may be identical or derived from the same sequence family. The primary differences may arise from at least one of the domains in which the logical root sequence is determined, the order of transformation steps (e.g., DFT/IFFT operations), the mathematical form of the generation expressions, and the implementation complexity and processing overhead. In some implementations, determining the root sequence directly in the frequency domain may reduce one transformation step compared to time-domain-root-based methods. This structural difference may affect processing latency, hardware implementation complexity, and flexibility in supporting domain-specific cyclic shift configurations.

Proposal #3 provides a preamble sequence generation order. In some implementations, the preamble sequence generation order may be determined for methods employing cyclic shift in the time domain (TD). The generation order may determine how logical root sequence indexes and cyclic shift values are enumerated within a given time-frequency occasion. In some implementations, the enumeration order may affect sequence indexing, detection behavior, and mapping consistency across different deployment scenarios. The following alternative configurations may be considered.

### Option 1: 1st TD Cyclic Shift of a Logical Root, 2nd Logical Root Sequence Index.

In some implementations, the preambles defined in each time-frequency occasion may be enumerated in increasing order of the first increasing cyclic shift Cₜᵥ of a logical root, and then in increasing order of the logical root sequence index. In some implementations, additional preamble sequences, in case M (a pre-defined or pre-configured value of the number of total preamble indexes) preambles cannot be generated from a single root sequence, are obtained from the root sequences with the consecutive logical indexes until all the M sequences are found. In some implementations, the logical root sequence order may be cyclic. For example, the logical index 0 may be consecutive to the max logical index. In some implementations, the mapping rule of the logical root sequence index to initial root sequence index may be obtained from a predefined table or pre-configured.

### Option 2: 1st Logical Root Sequence Index, 2nd TD Cyclic Shift of a Logical Root.

In some implementations, the preambles defined in each time-frequency occasion may be enumerated in increasing order of first increasing the logical root sequence index, and then in increasing order of cyclic shift Cₜᵥ of the logical roots. The preamble sequences, in case M (a pre-defined or pre-configured value of the number of total preamble indexes) preambles cannot be generated from a single cyclic shift Cₜᵥ, are obtained from the consecutive cyclic shift Cₜᵥ value until all the M sequences are found. In some implementations, the logical root sequence order may be cyclic. For example, the logical index 0 is consecutive to the max logical index. In some implementations, the mapping rule of the logical root sequence index to the initial root sequence index may be obtained from a predefined table or pre-configured. In some implementations, the selection of enumeration order may depend on system deployment scenarios, detection requirements, or implementation considerations. In some implementations, defining different generation orders may provide flexibility in supporting various random-access configurations, including scenarios requiring dynamic sequence allocation or scalable preamble indexing.

Proposal #3 provides a preamble sequence generation order. In some implementations, a preamble sequence generation order may be defined for methods employing cyclic shift in the frequency domain (FD). The generation order may determine how frequency-domain cyclic shift values and logical root sequence indexes are enumerated within a given time-frequency occasion. In some implementations, different enumeration orders may be configured depending on system requirements, deployment scenarios, or sequence allocation strategies. The following alternative configurations may be considered.

### Option 1: 1st FD Cyclic Shift of a Logical Root, 2nd Logical Root Sequence Index.

In some implementations, the preambles defined in each time-frequency occasion may be enumerated in increasing order of the first increasing cyclic shift C_{fv} of a logical root, and then in increasing order of the logical root sequence index. In some implementations, additional preamble sequences, in case M (a pre-defined or pre-configured value of the number of total preamble indexes) preambles cannot be generated from a single root sequence, may be obtained from the root sequences with the consecutive logical indexes until all the M sequences are found. In some implementations, the logical root sequence order may be cyclic. For example, the logical index 0 may be consecutive to the max logical index. In some implementations, the mapping rule of the logical root sequence index to the initial root sequence index may be obtained from a predefined table or pre-configured. In some implementations, this ordering structure may provide flexibility in allocating cyclic shifts across multiple logical roots, particularly in scenarios requiring scalable preamble indexing.

### Option 2: 1st Logical Root Sequence Index, 2nd FD Cyclic Shift of a Logical Root.

In some implementations, the preambles defined in each time-frequency occasion may be enumerated in increasing order of first increasing the logical root sequence index, and then in increasing order of cyclic shift C_{fv} of the logical roots. In some implementations, the preamble sequences, in case M (a pre-defined or pre-configured value of the number of total preamble indexes) preambles cannot be generated from a single cyclic shift C_{fv}, may be obtained from the consecutive cyclic shift C_{fv} value until all the M sequences are found. In some implementations, the logical root sequence order may be cyclic. For example, the logical index 0 may be consecutive to the max logical index. In some implementations, the mapping rule of the logical root sequence index to the initial root sequence index may be obtained from a predefined table or pre-configured. In some implementations, this ordering approach may simplify implementation in systems where logical root allocation is prioritized over cyclic shift allocation. In some implementations, the selection of enumeration order may depend on system configuration, random-access load distribution, detection requirements, or hardware implementation constraints. In some implementations, defining multiple generation orders for FD cyclic shift may improve flexibility in supporting diverse deployment scenarios, including large-scale random-access configurations or dynamically configurable preamble indexing.

Proposal #3 provides a preamble sequence generation order for dual-domain cyclic shift configurations.

In some implementations, for a preamble sequence generation method employing cyclic shift in both the time domain (TD) and the frequency domain (FD), an enumeration order may be defined to determine how logical root sequence indexes, time-domain cyclic shift values Ctv, and frequency-domain cyclic shift values C_{fv} are ordered within a given time-frequency occasion. In some implementations, different permutation orders may be configured depending on system design, detection strategies, or deployment requirements. The following alternative configurations may be considered.

### Option 1: 1st TD Cyclic Shift of a Logical Root, 2nd FD Cyclic Shift of a Logical Root, and 3rd Logical Root Sequence Index.

In some implementations, the preambles defined in each time-frequency occasion may be enumerated in increasing order of first increasing cyclic shift Cₜᵥ of a logical root with a cyclic shift C_{fv}, second in increasing order of cyclic shift C_{fv} of a logical root, and then in increasing order of the logical root sequence index. In some implementations, additional preamble sequences, in case M (a pre-defined or pre-configured value of the number of total preamble indexes) preambles cannot be generated from a single root sequence, may be obtained from the root sequences with the consecutive logical indexes until all the M sequences are found. In some implementations, the logical root sequence order may be cyclic. For example, the logical index 0 may be consecutive to the max logical index. In some implementations, the mapping rule of the logical root sequence index to the initial root sequence index may be obtained from a predefined table or pre-configured.

### Option 2: 1st FD Cyclic Shift of a Logical Root, 2nd TD Cyclic Shift of a Logical Root, and 3rd Logical Root Sequence Index.

In some implementations, the preambles defined in each time-frequency occasion may be enumerated in increasing order of first increasing cyclic shift C_{fv} of a logical root with a cyclic shift Cₜᵥ, second in increasing order of cyclic shift Cₜᵥ of a logical root, and then in increasing order of the logical root sequence index. In some implementations, additional preamble sequences, in case M (a pre-defined or pre-configured value of the number of total preamble indexes) preambles cannot be generated from a single root sequence, may be obtained from the root sequences with the consecutive logical indexes until all the M sequences are found. In some implementations, the logical root sequence order may be cyclic. For example, the logical index 0 may be consecutive to the max logical index. In some implementations, the mapping rule of the logical root sequence index to the initial root sequence index may be obtained from a predefined table or pre-configured.

### Option 3: 1st TD Cyclic Shift of a Logical Root, 2nd Logical Root Sequence Index, and 3rd FD Cyclic Shift of a Logical Root.

In some implementations, the preambles defined in each time-frequency occasion may be enumerated in increasing order of first increasing cyclic shift Cₜᵥ of a logical root with cyclic shift C_{fv}, second in increasing order of logical root sequence index with cyclic shift C_{fv}, and then in increasing order of the cyclic shift C_{fv} of the logical roots. In some implementations, additional preamble sequences, in case M (a pre-defined or pre-configured value of the number of total preamble indexes) preambles cannot be generated from a single root sequence and a single cyclic shift C_{fv}, may be obtained from the root sequences with the consecutive logical indexes and consecutive cyclic shift C_{fv} until all the M sequences are found. In some implementations, the logical root sequence order may be cyclic. For example, the logical index 0 may be consecutive to the max logical index. In some implementations, the mapping rule of the logical root sequence index to the initial root sequence index may be obtained from a predefined table or pre-configured.

### Option 4: 1st FD Cyclic Shift of a Logical Root, 2nd Logical Root Sequence Index, and 3rd TD Cyclic Shift of a Logical Root.

In some implementations, the preambles defined in each time-frequency occasion may be enumerated in increasing order of first increasing cyclic shift C_{fv} of a logical root with cyclic shift Cₜᵥ, second in increasing order of logical root sequence index with cyclic shift Cₜᵥ, and then in increasing order of the cyclic shift Cₜᵥ of the logical roots. In some implementations, additional preamble sequences, in case M (a pre-defined or pre-configured value of the number of total preamble indexes) preambles cannot be generated from a single root sequence and a single cyclic shift Cₜᵥ, may be obtained from the root sequences with the consecutive logical indexes and consecutive cyclic shift Cₜᵥ until all the M sequences are found. In some implementations, the logical root sequence order may be cyclic. For example, the logical index 0 may be consecutive to the max logical index. In some implementations, the mapping rule of the logical root sequence index to the initial root sequence index may be obtained from a predefined table or pre-configured.

### Option 5: 1st Logical Root Sequence Index, 2nd TD Cyclic Shift of a Logical Root, and 3rd FD Cyclic Shift of a Logical Root.

In some implementations, the preambles defined in each time-frequency occasion may be enumerated in increasing order of first increasing logical root sequence index with cyclic shift Cₜᵥ and C_{fv}, second in increasing order of cyclic shift Cₜᵥ of a logical root with cyclic shift C_{fv}, and then in increasing order of the cyclic shift C_{fv} of the logical roots. In some implementations, additional preamble sequences, in case M (a pre-defined or pre-configured value of the number of total preamble indexes) preambles cannot be generated from a single root sequence and a single cyclic shift Cₜᵥ or C_{fv}, may be obtained from the root sequences with the consecutive logical indexes and consecutive cyclic shift Cₜᵥ or C_{fv} until all the M sequences are found. In some implementations, the logical root sequence order may be cyclic. In some implementations, the logical index 0 may be consecutive to the max logical index. In some implementations, the mapping rule of the logical root sequence index to the initial root sequence index may be obtained from a predefined table or pre-configured.

### Option 6: 1st Logical Root Sequence Index, 2nd FD Cyclic Shift of a Logical Root, and 3rd TD Cyclic Shift of a Logical Root.

In some implementations, the preambles defined in each time-frequency occasion may be enumerated in increasing order of first increasing logical root sequence index with cyclic shift Cₜᵥ and C_{fv}, second in increasing order of cyclic shift C_{fv} of a logical root with cyclic shift Cₜᵥ, and then in increasing order of the cyclic shift Cₜᵥ of the logical roots. In some implementations, additional preamble sequences, in case M (a pre-defined or pre-configured value of the number of total preamble indexes) preambles cannot be generated from a single root sequence and a single cyclic shift Ctv or C_{fv}, may be obtained from the root sequences with the consecutive logical indexes and consecutive cyclic shift Cₜᵥ or C_{fv} until all the M sequences are found. For example, the logical root sequence order may be cyclic. In some implementations, the logical index 0 may be consecutive to the max logical index. In some implementations, the mapping rule of the logical root sequence index to the initial root sequence index may be obtained from a predefined table or pre-configured. In some implementations, the selection among these permutation orders may depend on system configuration, random-access load balancing, detection ordering requirements, or hardware design constraints. In some implementations, supporting multiple enumeration orders for dual-domain cyclic shift configurations may significantly enhance flexibility, scalability, and compatibility with future communication systems.

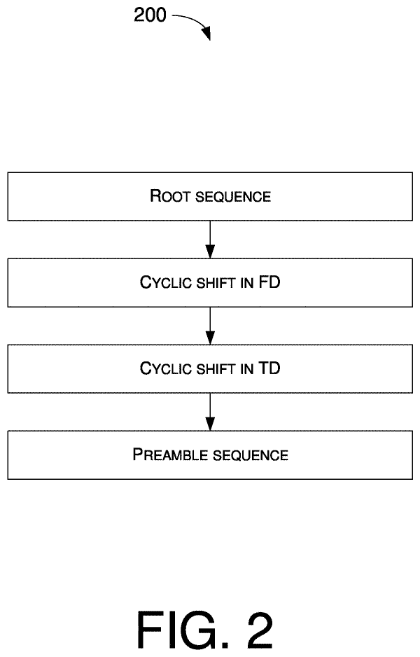

Proposal #3 provides a preamble sequence generation order for dual-domain cyclic shift configurations. FIG. 2 illustrates an example scenario 200 in accordance with an implementation of the present disclosure. In some implementations, an example of the preamble generation order corresponding to Option 1 (i.e., first time-domain cyclic shift of a logical root, second frequency-domain cyclic shift of a logical root, and third logical root sequence index) may be illustrated as shown in FIG. 2. In some implementations, if the required number of preamble sequences cannot be generated from a single root sequence under a given cyclic shift configuration, additional sequences may be derived from root sequences with consecutive logical indexes until all required sequences are obtained. For the case of N_{tcs}=10, N_{fcs}=15, total preamble sequence root number=33 (u=0~32), M=64, L_{RA}=31, logical root index starts from 0 as illustrated in Table 1. The enumeration example shown in Table 1 illustrates one possible ordering structure under the corresponding configuration.

TABLE 1

| Preamble | Logical Root | FD cyclic | TD cyclic |
|---|---|---|---|
| index | index | shift value | shift value |
| 0 | 0 | 0*N_{fcs} | 0*N_{tcs} |
| 1 | 0 | 0*N_{fcs} | 1*N_{tcs} |
| 2 | 0 | 0*N_{fcs} | 2*N_{tcs} |
| 3 | 0 | 1*N_{fcs} | 0*N_{tcs} |
| 4 | 0 | 1*N_{fcs} | 1*N_{tcs} |
| 5 | 0 | 1*N_{fcs} | 2*N_{tcs} |
| 6 | 1 | 0*N_{fcs} | 0*N_{tcs} |
| . . . | . . . | . . . | . . . |
| 62 | 10 | 0*N_{fcs} | 2*N_{tcs} |
| 63 | 10 | 1*N_{fcs} | 0*N_{tcs} |

Proposal #3 provides a preamble sequence generation order for dual-domain cyclic shift configurations. Regarding other aspects, in some implementations, it should be noted that the TD sequence represents a sequence located in the time domain, which is similar to a sequence resource mapped in the frequency domain (e.g., sequence x_{u,tv}, etc.) and using the modulation method of DFT-s-OFDM. In some implementations, it should be noted that the FD sequence represents a sequence located in the frequency domain, which is similar to a sequence resource mapped in the frequency domain (e.g., sequence x_{u,tv}, etc.) and using the modulation method of OFDM. In some implementations, the sequence or root sequence mentioned in this disclosure is a sequence of good cross-correlation and/or auto-correlation property, but not limited to M sequences, Gold sequences, Z4 sequences (a 4-phase sequence), ZC sequences, Costas sequences, pseudo random sequences, sequences generated via Golomb ruler, etc. In some implementations, the N_{tcs} and N_{fcs} are configured by network, RRC, MAC CE, DCI or SIB(s). The N_{tcs} and N_{fcs} is chosen from a predefined table or calculated via one or more pre-defined formulas. In some implementations, a preamble may include one or multiple times of preamble sequences. In some implementations, a preamble may include one or multiple repetitions of the preamble sequence, depending on system configuration or deployment requirements.

In some implementations, the NR specification defines a preamble generation order in which a root sequence is first selected, followed by applying time-domain (TD) cyclic shifts, and the preamble index increases according to the TD cyclic shift ordering. In such baseline behavior, the enumeration structure is primarily based on TD cyclic shift under a selected root sequence, and frequency-domain cyclic shift is not defined as an additional enumeration dimension. In some implementations, the present disclosure extends this baseline framework by introducing additional cyclic shift dimensions into the preamble generation order. For example, when a frequency-domain (FD) cyclic shift is introduced in addition to a TD cyclic shift, multiple generation order structures may be supported. In some implementations, the generation order may first increase TD cyclic shift and then FD cyclic shift, or first increase FD cyclic shift and then TD cyclic shift. In some implementations, the logical root sequence index may be incremented before or after one or more cyclic shift dimensions. Accordingly, different ordering combinations among TD cyclic shift, FD cyclic shift, and logical root sequence index may define different enumeration structures. In some implementations, the generation order may influence system behavior. For example, different cyclic shift ordering structures may affect receiver detection complexity, correlation properties among generated preamble sequences, implementation complexity, memory organization, and signal processing latency. In some implementations, certain ordering rules may result in improved correlation distribution or simplified receiver search structures. In some implementations, the generation order may therefore be selected according to deployment scenarios, hardware constraints, or detection strategy considerations.

In some implementations, under the NR baseline, the system supports 64 preamble sequences indexed from 0 to 63, and the enumeration follows a predefined TD-cyclic-shift-based ordering rule. In some implementations, the present disclosure introduces a multi-layer cyclic enumeration structure including TD cyclic shift, FD cyclic shift, and logical root sequence index. In some implementations, all possible combinations of these dimensions may be generated according to a selected ordering rule. In some implementations, sequence generation may continue until a predefined number M of preamble sequences are obtained. In some implementations, M may be a predefined value, for example, 64 in NR systems. If the total number of possible combinations exceeds M, generation may stop once M sequences are obtained. If the total number of combinations is less than M, additional root sequences or cyclic shift values may be used until M sequences are generated. In some implementations, the parameter M represents the total number of supported preamble sequences in a given configuration. In some implementations, in current NR systems, M is fixed to 64 and is not dynamically configured by the network. In some implementations, a UE may select and transmit one preamble sequence among the M possible sequences, while a gNB may be configured to detect all M possible sequences. In some implementations, the introduction of FD cyclic shift and multi-dimensional enumeration may expand the design space from which the M sequences are derived, without necessarily changing the value of M. In some implementations, additional configuration parameters may be introduced to support the extended generation framework. For example, such parameters may include frequency-domain cyclic shift value (CFV), time-domain cyclic shift value (CTV), and logical root sequence index. In some implementations, these parameters may be configured by the network via RRC signaling, MAC CE, DCI, or SIB(s). In some implementations, the UE generation mechanism may support both TD and FD cyclic shifts. In some implementations, the gNB detection complexity may vary depending on the selected generation order, and the specific detection algorithm may be implementation-dependent. In some implementations, compared to the NR baseline which includes only TD sequence and TD cyclic shift without frequency-domain cyclic shift, the present disclosure introduces extended capabilities including frequency-domain cyclic shift, joint TD and FD cyclic shift combinations, FD sequence as a root definition option, expanded generation order structures, and extended enumeration rules incorporating multiple cyclic dimensions. In some implementations, these extensions may provide increased flexibility in preamble design, improved sequence diversity, and enhanced adaptability for random access configuration.

### Illustrative Implementations

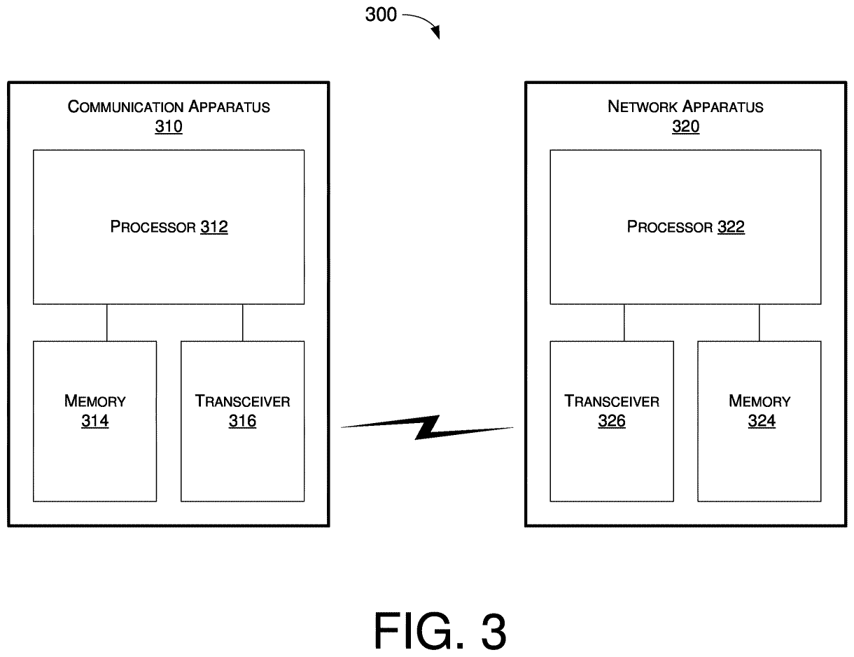

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes, and methods described herein pertaining to random access preamble format and generation in wireless communications, including scenarios/schemes described above as well as processes 400 and 500 described below.

Communication apparatus 310 may be a part of an electronic apparatus, which may be a UE such as a portable or mobile apparatus, a wearable apparatus, a wireless communication apparatus, or a computing apparatus. For instance, communication apparatus 310 may be implemented in a smartphone, a smartwatch, a personal digital assistant, an electronic control unit (ECU) in a vehicle, a digital camera, or a computing equipment such as a tablet computer, a laptop computer, or a notebook computer. Communication apparatus 310 may also be a part of a machine-type apparatus, which may be an IoT, NB-IoT, or IIoT UE such as an immobile or a stationary apparatus, a home apparatus, a roadside unit (RSU), a wire communication apparatus, or a computing apparatus. For instance, communication apparatus 310 may be implemented in a smart thermostat, a smart fridge, a smart door lock, a wireless speaker, or a home control center. Alternatively, communication apparatus 310 may be implemented in the form of one or more integrated-circuit (IC) chips such as, for example and without limitation, one or more single-core processors, one or more multi-core processors, one or more reduced-instruction-set computing (RISC) processors, or one or more complex-instruction-set computing (CISC) processors. Communication apparatus 310 may include at least some of those components shown in FIG. 3, such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a satellite, a BS, a cell, a router, or a gateway of a 4G/5G/B5G/6G, NR, IoT, NB-IoT, IIoT, or NTN network. For instance, network apparatus 320 may be implemented in a satellite or an eNB/gNB/TRP in a 4G/5G, NR, IoT, NB-IoT, IIoT, or NTN network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3, such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks in a device (e.g., as represented by communication apparatus 310) and a network node (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, transceiver 316 may be capable of wirelessly communicating with different types of UEs and/or wireless networks of different RATs. In some implementations, transceiver 316 may be equipped with a plurality of antenna ports (not shown) such as, for example, four antenna ports. That is, transceiver 316 may be equipped with multiple transmit antennas and multiple receive antennas for beamforming and multiple-input multiple-output (MIMO) wireless communications. In some implementations, network apparatus 320 may also include a transceiver 326 coupled to processor 322. Transceiver 326 may include a transceiver capable of wirelessly transmitting and receiving data. In some implementations, transceiver 326 may be capable of wirelessly communicating with different types of UEs of different RATs. In some implementations, transceiver 326 may be equipped with a plurality of antenna ports (not shown) such as, for example, four antenna ports. That is, transceiver 326 may be equipped with multiple transmit antennas and multiple receive antennas for beamforming and MIMO wireless communications.

In some implementations, communication apparatus 310 may further include a memory 314 coupled to processor 312 and capable of being accessed by processor 312 and storing data therein. In some implementations, network apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM), and/or phase-change memory.

Each of communication apparatus 310 and network apparatus 320 may be a communication entity capable of communicating with each other using various proposed schemes in accordance with the present disclosure. For illustrative purposes and without limitation, a description of capabilities of communication apparatus 310, as a UE, and network apparatus 320, as a network node, is provided below with processes 400 and 500.

### Illustrative Processes

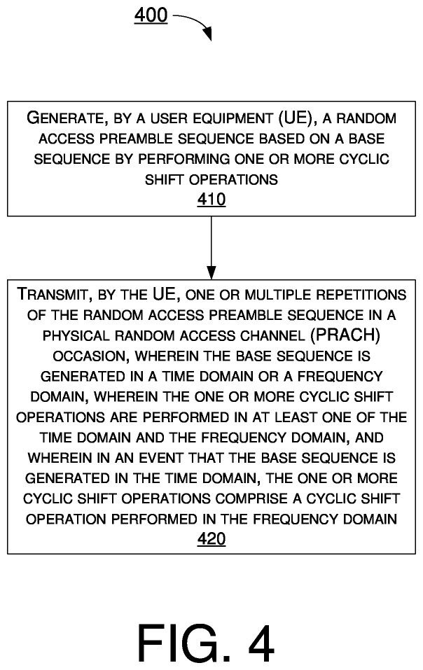

FIG. 4 illustrates an example process 400 in accordance with an implementation of the present disclosure. Process 400 may be an example implementation of above scenarios/schemes, whether partially or completely, with respect to random access preamble format and generation in wireless communications. Process 400 may represent an aspect of implementation of features of communication apparatus 310. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by or in communication apparatus 310 or any suitable UE or machine-type device. Solely for illustrative purposes and without limitation, process 400 is described below in the context of communication apparatus 310, as a UE, and network apparatus 320, as a network node (e.g., satellite/gNB/TRP/relay). Process 400 may begin at block 410.

At block 410, process 400 may involve processor 312 of communication apparatus 310, generating a random access preamble sequence based on a base sequence by performing one or more cyclic shift operations. Process 400 may proceed from block 410 to block 420.

At block 420, process 400 may involve processor 312 transmitting, via the transceiver 316, one or multiple repetitions of the random access preamble sequence in a physical random access channel (PRACH) occasion. The base sequence may be generated in a time domain or a frequency domain, the one or more cyclic shift operations may be performed in at least one of the time domain and the frequency domain, and in an event that the base sequence may be generated in the time domain, the one or more cyclic shift operations may comprise a cyclic shift operation performed in the frequency domain.

In some implementations, the cyclic shift operation performed in the frequency domain may be associated with a frequency-domain cyclic shift value. In some implementations, the frequency-domain cyclic shift value may be configured by a network node. In some implementations, the one or more cyclic shift operations may comprise a time-domain cyclic shift operation and a frequency-domain cyclic shift operation. In some implementations, for generating a plurality of random access preamble sequences, values associated with the time-domain cyclic shift operation may be enumerated prior to values associated with the frequency-domain cyclic shift operation. In some implementations, for generating a plurality of random access preamble sequences, values associated with the frequency-domain cyclic shift operation may be enumerated prior to values associated with the time-domain cyclic shift operation. In some implementations, the base sequence generated in the frequency domain may be mapped to resource elements without performing a discrete Fourier transform (DFT). In some implementations, the base sequence may have a cross-correlation property or an auto-correlation property suitable for random access detection, and the base sequence may be selected from at least one of: an M sequence, a Gold sequence, a Z4 sequence, a 4-phase sequence, a Zadoff-Chu (ZC) sequence, a CAZAC sequence, a poly-phase sequence, a sequence generated via a Golomb ruler, and a pseudo-random sequence. In some implementations, the method may further comprise generating one of a plurality of random access preamble sequences, and the plurality of random access preamble sequences may be generated by enumerating a combination of a logical root index, a time-domain cyclic shift value, and a frequency-domain cyclic shift value. In some implementations, the plurality of random access preamble sequences may correspond to a predefined number of candidate preamble sequences, and one of the candidate preamble sequences may be selected by the UE for transmission. In some implementations, a sequence length of the base sequence may be determined based on a configured physical random access channel (PRACH) preamble format.

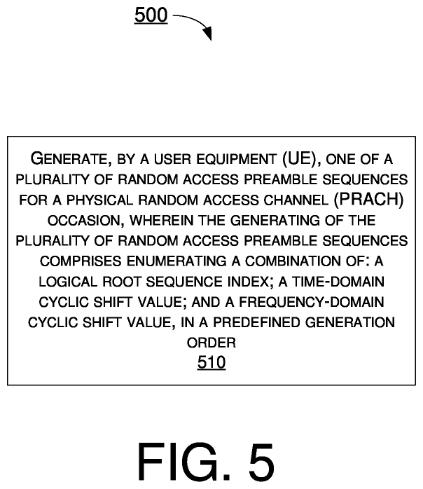

FIG. 5 illustrates an example process 500 in accordance with an implementation of the present disclosure. Process 500 may be an example implementation of above scenarios/schemes, whether partially or completely, with respect to random access preamble format and generation in wireless communications. Process 500 may represent an aspect of implementation of features of communication apparatus 310. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by or in communication apparatus 310 or any suitable UE or machine-type device. Solely for illustrative purposes and without limitation, process 500 is described below in the context of communication apparatus 310, as a UE, and network apparatus 320, as a network node (e.g., satellite/gNB/TRP/relay). Process 500 may begin at block 510.

At block 510, process 500 may involve processor 312 of communication apparatus 310, generating one of a plurality of random access preamble sequences for a physical random access channel (PRACH) occasion. The generating of the plurality of random access preamble sequences may comprise enumerating a combination of a logical root sequence index, a time-domain cyclic shift value, and a frequency-domain cyclic shift value, in a predefined generation order.

In some implementations, in an event that the random access preamble sequence may be generated with a cyclic shift in a time domain, the predefined generation order for the plurality of random access preamble sequences to choose from may be in an increasing order of first, the time-domain cyclic shift value and second, the logical root sequence index. In some implementations, in an event that the random access preamble sequence is generated with a cyclic shift in both the time domain and the frequency domain, the predefined generation order for the plurality of random access preamble sequences to choose from is in an increasing order of first, the time-domain cyclic shift value, second, the frequency-domain cyclic shift value, and third, the logical root sequence index. In some implementations, in an event that the random access preamble sequence may be generated with a cyclic shift in both the time domain and the frequency domain, the predefined generation order for the plurality of random access preamble sequences to choose from may be in increasing order of first, the time-domain cyclic shift value, second, the logical root sequence index, and third, the frequency-domain cyclic shift value. In some implementations, process 500 may further involve processor 312 of communication apparatus 310 terminating the generating in an event that a predefined number of preamble sequences is reached. In some implementations, the predefined generation order for the plurality of random access preamble sequences to choose from may be configured to generate random access preamble sequences associated with a same logical root sequence index consecutively before generating random access preamble sequences associated with a different logical root sequence index. In some implementations, the predefined generation order for the plurality of random access preamble sequences to choose from may indicate a priority between cyclic shift values in a time domain and cyclic shift values in a frequency domain, and cyclic shift values in one of the time domain and the frequency domain may be enumerated before cyclic shift values in another of the time domain and the frequency domain may be enumerated.

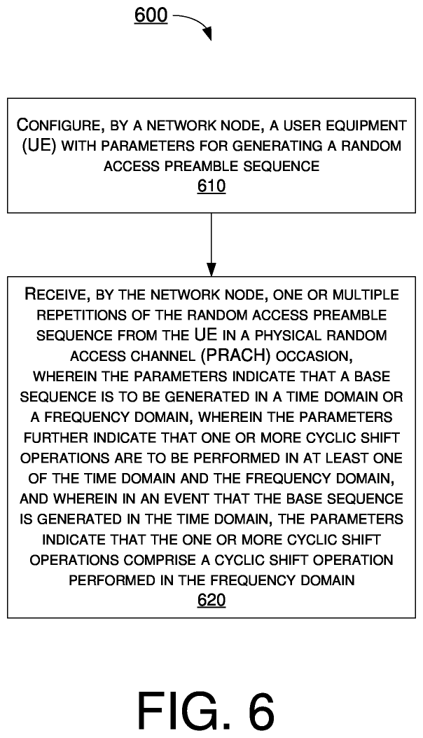

FIG. 6 illustrates an example process 600 in accordance with an implementation of the present disclosure. Process 600 may be an example implementation of above scenarios/schemes, whether partially or completely, with respect to random access preamble format and generation in wireless communications. Process 600 may represent an aspect of implementation of features of network apparatus 320. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by or in network apparatus 320 as well as any variations thereof. Solely for illustrative purposes and without limitation, process 600 is described below in the context of communication apparatus 310, as a UE, and network apparatus 320, as a network node (e.g., satellite/gNB/TRP/relay). Process 600 may begin at block 610.

At block 610, process 600 may involve processor 322 of network apparatus 320, configuring a user equipment (UE) with parameters for generating a random access preamble sequence. Process 600 may proceed from block 610 to block 620.

At block 620, process 600 may involve processor 322 transmitting, via transceiver 326, one or multiple repetitions of the random access preamble sequence from the UE in a physical random access channel (PRACH) occasion. The parameters may indicate that a base sequence is to be generated in a time domain or a frequency domain, the parameters may further indicate that one or more cyclic shift operations are to be performed in at least one of the time domain and the frequency domain, and in an event that the base sequence is generated in the time domain, the parameters may indicate that the one or more cyclic shift operations comprise a cyclic shift operation performed in the frequency domain.

In some implementations, the cyclic shift operation performed in the frequency domain may be associated with a frequency-domain cyclic shift value.

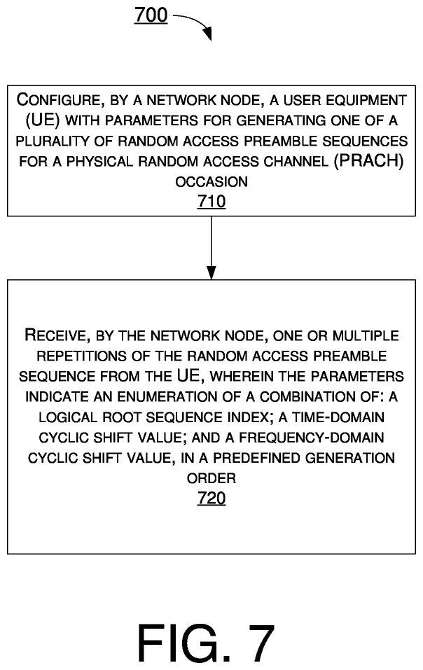

FIG. 7 illustrates an example process 700 in accordance with an implementation of the present disclosure. Process 700 may be an example implementation of above scenarios/schemes, whether partially or completely, with respect to random access preamble format and generation in wireless communications. Process 700 may represent an aspect of implementation of features of network apparatus 320. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by or in network apparatus 320 as well as any variations thereof. Solely for illustrative purposes and without limitation, process 700 is described below in the context of communication apparatus 310, as a UE, and network apparatus 320, as a network node (e.g., satellite/gNB/TRP/relay). Process 700 may begin at block 710.

At block 710, process 700 may involve processor 322 of network apparatus 320, configuring a user equipment (UE) with parameters for generating one of a plurality of random access preamble sequences for a physical random access channel (PRACH) occasion. Process 700 may proceed from block 710 to block 720.

At block 720, process 700 may involve processor 322 receiving, via transceiver 326, one or multiple repetitions of the random access preamble sequence from the UE. The parameters may indicate an enumeration of a combination of a logical root sequence index, a time-domain cyclic shift value, and a frequency-domain cyclic shift value, in a predefined generation order.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a user equipment (UE), a random access preamble sequence based on a base sequence by performing one or more cyclic shift operations; and
transmitting, by the UE, one or multiple repetitions of the random access preamble sequence in a physical random access channel (PRACH) occasion,
wherein the base sequence is generated in a time domain or a frequency domain,
wherein the one or more cyclic shift operations are performed in at least one of the time domain and the frequency domain, and
wherein in an event that the base sequence is generated in the time domain, the one or more cyclic shift operations comprise a cyclic shift operation performed in the frequency domain.

2. The method of claim 1, wherein the cyclic shift operation performed in the frequency domain is associated with a frequency-domain cyclic shift value.

3. The method of claim 2, wherein the frequency-domain cyclic shift value is configured by a network node.

4. The method of claim 1, wherein the one or more cyclic shift operations comprise a time-domain cyclic shift operation and a frequency-domain cyclic shift operation.

5. The method of claim 4, wherein, for generating a plurality of random access preamble sequences, values associated with the time-domain cyclic shift operation are enumerated prior to values associated with the frequency-domain cyclic shift operation.

6. The method of claim 4, wherein, for generating a plurality of random access preamble sequences, values associated with the frequency-domain cyclic shift operation are enumerated prior to values associated with the time-domain cyclic shift operation.

7. The method of claim 1, wherein the base sequence generated in the frequency domain is mapped to resource elements without performing a discrete Fourier transform (DFT).

8. The method of claim 1, wherein the base sequence has a cross-correlation property or an auto-correlation property suitable for random access detection, and wherein the base sequence is selected from at least one of: an M sequence, a Gold sequence, a Z4 sequence, a 4-phase sequence, a Zadoff-Chu (ZC) sequence, a CAZAC sequence, a poly-phase sequence, a sequence generated via a Golomb ruler, and a pseudo-random sequence.

9. The method of claim 1, further comprising:
generating, by the UE, one of a plurality of random access preamble sequences, wherein the plurality of random access preamble sequences are generated by enumerating a combination of:
a logical root index;
a time-domain cyclic shift value; and
a frequency-domain cyclic shift value.

10. The method of claim 9, wherein the plurality of random access preamble sequences corresponds to a predefined number of candidate preamble sequences, and wherein one of the candidate preamble sequences is selected by the UE for transmission.

11. The method of claim 1, wherein a sequence length of the base sequence is determined based on a configured physical random access channel (PRACH) preamble format.

12. A method, comprising:
generating, by a user equipment (UE), one of a plurality of random access preamble sequences for a physical random access channel (PRACH) occasion,
wherein the generating of the plurality of random access preamble sequences comprises enumerating a combination of:
a logical root sequence index;
a time-domain cyclic shift value; and
a frequency-domain cyclic shift value,
in a predefined generation order.

13. The method of claim 12, wherein in an event that the random access preamble sequence is generated with a cyclic shift in a time domain, the predefined generation order for the plurality of random access preamble sequences to choose from is in an increasing order of:
first, the time-domain cyclic shift value; and
second, the logical root sequence index.

14. The method of claim 12, wherein in an event that the random access preamble sequence is generated with a cyclic shift in both the time domain and the frequency domain, the predefined generation order for the plurality of random access preamble sequences to choose from is in an increasing order of:
first, the time-domain cyclic shift value;
second, the frequency-domain cyclic shift value; and
third, the logical root sequence index.

15. The method of claim 12, wherein in an event that the random access preamble sequence is generated with a cyclic shift in both the time domain and the frequency domain, the predefined generation order for the plurality of random access preamble sequences to choose from is in increasing order of:
first, the time-domain cyclic shift value;
second, the logical root sequence index; and
third, the frequency-domain cyclic shift value.

16. The method of claim 12, further comprising:
terminating, by the UE, the generating of the plurality of random access preamble sequences to choose from in an event that a predefined number of preamble sequences is reached.

17. The method of claim 12, wherein the predefined generation order for the plurality of random access preamble sequences to choose from is configured to generate random access preamble sequences associated with a same logical root sequence index consecutively before generating random access preamble sequences associated with a different logical root sequence index.

18. The method of claim 12, wherein the predefined generation order for the plurality of random access preamble sequences to choose from indicates a priority between cyclic shift values in a time domain and cyclic shift values in a frequency domain, and wherein cyclic shift values in one of the time domain and the frequency domain are enumerated before cyclic shift values in another of the time domain and the frequency domain are enumerated.

19. A method, comprising:
configuring, by a network node, a user equipment (UE) with parameters for generating a random access preamble sequence; and
receiving, by the network node, one or multiple repetitions of the random access preamble sequence from the UE in a physical random access channel (PRACH) occasion,
wherein the parameters indicate that a base sequence is to be generated in a time domain or a frequency domain,
wherein the parameters further indicate that one or more cyclic shift operations are to be performed in at least one of the time domain and the frequency domain, and
wherein in an event that the base sequence is generated in the time domain, the parameters indicate that the one or more cyclic shift operations comprise a cyclic shift operation performed in the frequency domain.

20. The method of claim 19, wherein the cyclic shift operation performed in the frequency domain is associated with a frequency-domain cyclic shift value.
